(19) United States
(12) Patent Application Publication
(10) Pub. No.: US 2003/0200854 A1
(43) Pub. Date: Oct. 30, 2003

(54) Cutting machine for food

(76) Inventors: Heinrich Graef, Arnsberg (DE); Andreas Schmidt, Soest (DE)

Correspondence Address: Stewart L. Gitler, Esq., HOFFMAN, WASSON & GITLER, PC, Suite 522, 2361 Jefferson Davis Highway, Arlington, VA, 22202, US

(21) Appl. No.: 10/423,984

(22) Filed: Apr. 28, 2003

(30) Foreign Application Priority Data
Apr. 30, 2002 (DE) 102 19 460.2

(51) Int. Cl. B26D 1/14

(52) U.S. Cl. 83/707; 83/932

(57) ABSTRACT

A cutting machine for food including a motor housing with one blade which is rotationally held on or in it, a carriage which is used to support the material to be cut and which can be moved parallel to the cutting plane of the blade, and means for carriage guidance to which the carriage is attached or can be attached, and a base plate which is used directly or indirectly for holding the motor housing, the cutting machine having a base part which encompasses the base plate and a carrier part which is made essentially in one piece with it, and the motor housing being held on the carrier part. Furthermore, this invention relates to a base part for one such cutting machine.

### BACKGROUND OF THE INVENTION

This invention relates to a cutting machine for food, including a motor housing with one blade which is rotationally held on or in it, a carriage which is used to support the material to be cut and which can be moved parallel to the cutting plane of the blade, and means for carriage guidance to which the carriage is attached or can be attached, and a base plate which is used directly or indirectly for holding the motor housing. Furthermore, this invention relates to a base part for one such cutting machine.

A cutting machine of the aforementioned type is known from German utility model G 83 08 635. The cutting machine described in it has a base plate on which a motor housing is screwed. A circular knife is rotationally held on the motor housing. Furthermore, on the motor housing a carriage guide is attached on which a carriage can be moved back and forth parallel to the cutting plane of the blade. Furthermore, a stop plate also is movably attached to the motor housing perpendicular to the cutting plane of the blade.

It is disadvantageous in the aforementioned cutting machine that a relatively large number of working steps are necessary for producing the cutting machine. Furthermore, it must be possible to screw a relatively large number of complex parts to one another and especially the motor housing must be made relatively complex, because it must have at the same time a carriage guide or must be connectable to a carriage guide and the stop plate must be movably held on the housing.

In the cutting machine known from the existing art, between the base plate and the carriage or the stop plate there is a recess. For example, a catch tray for the material to be cut can be moved into this recess. But it happens that the recess is comparatively small and extends only under the carriage and the edge of the blade. This is due especially to the fact that the machine housing is permanently connected to the base plate over the entire width, i.e. the direction perpendicular to the feed direction of the carriage, and is screwed onto it. Underneath the motor housing thus there is no room for introducing a receiving tray shell.

Furthermore, German utility model DE 296 22 410 shows a cutting machine with a machine housing screwed onto a base plate which is made as a profile part. In the cutting machine described in this utility model, the motor housing extends in the direction perpendicular to the feed direction of the carriage over the entire width of the base plate. By executing the base plate as a profile part there is on the one hand the possibility that a drawer can be placed in the base plate. On the other hand, there is the possibility that a cutting board can be pushed under the shoulder of the base plate. The intermediate space between the shoulder of the base plate and the section of the base plate under it is however so narrow that at best a very flat cutting board can be inserted here. In the cutting machine known from this utility model it is not possible to push a receiving tray shell or the like for the material to be cut under the machine housing.

The object of the invention is to devise a cutting machine of the initially mentioned type which can be produced more economically and/or can be used for more diverse purposes.

### SUMMARY OF THE INVENTION

According to the invention 1, it is provided that the cutting machine has a base part which encompasses the base plate and a carrier part which is made in one piece with it, and the motor housing being held on the carrier part. By providing a one-piece base part which is thus simple to produce and on which the motor housing can be held, the installation of the cutting machine is simplified.

Further, it is provided that between the motor housing and the base plate there is a carrier part which holds the motor housing, the carrier part being made such that between the motor housing and the base plate a recess is formed into which articles can be inserted from the outside. This recess makes it possible to push the receiving tray or the like for the material to be cut under the entire motor housing or at least under one part of the motor housing.

The recess can preferably extend essentially parallel to the direction of displacement of the carriage. For example, the recess could extend over the entire length of the base plate in the displacement direction of the carriage, so that a catch tray or the like can be pushed from one side to under the motor housing and to under the carriage.

In addition there is the possibility that the carrier part is made such that between the carriage and the base plate a recess is formed into which articles can be inserted from the outside. To do this, the carrier part in the displacement direction of the carriage can end essentially underneath the motor housing. In this way the base plate is connected to the motor housing only via a comparatively small carrier part which covers only a small part of the surface of the base plate. The remainder of the base plate can thus be used on the one hand for placing articles and on the other enables very effective and simple cleaning of this section of the base plate which is not covered by any other part of the machine.

It is possible for at least one recess in the connection direction between the base plate and the motor housing or between the base plate and the carriage at least in sections to have an extension of at least 2 cm, especially roughly 3 cm to 5 cm. A recess this high is quite sufficient to introduce a receiving tray with a comparatively high edge into it as well.

In particular, it can be provided that means for guiding the carriage are made on the carrier part. Thus, there need not be, in addition to the carrier part of the base part, another part for guiding the carriage which must be screwed onto the motor housing in a step which is complex under certain circumstances. This can also reduce the costs of producing the cutting machine.

According to one preferred embodiment of this invention the base part is made as an extruded section, especially as an aluminum extruded section. One such extruded section can be produced very easily and very economically.

It is possible for the means for guiding the carriage to encompass a receiving groove which is made on the carrier part, which extends in the displacement direction of the carriage and into which the engagement part of the carriage can fit. Furthermore, it can be provided that means for guiding the carriage comprise a top surface which is made on the carrier part and which is located spaced apart and parallel to the base plate and can be used as a support surface for the corresponding support element of the carriage. The means for guiding the carriage can be easily implemented on the carrier part of the base part by these measures.

According to one preferred embodiment of the invention, it can be provided that the cutting machine has a stop plate which is aligned parallel to the cutting plane of the blade and can be moved in the direction perpendicular to the cutting plane of the blade in order to vary the thickness of the cut slice of the material which was to be cut. Here it is possible for the stop plate to be mounted on the carrier part. As a result of the fact that the stop plate can be attached to the carrier part of the base part, the production cost of the cutting machine as claimed in the invention is further reduced. In particular, the motor housing need not be made complex in order to enable one possibility for attachment of the stop plate.

It is possible for the carrier part to have a mounting surface which is aligned perpendicular to the base plate and to which the motor housing is attached. Furthermore, it can be provided that the stop plate is adjustably mounted on the mounting surface. The mounting surface can thus also be used both for attachment of the motor housing and also for attachment of the stop plate, by which installation of the cutting machine is further simplified.

It is possible for the bottom of the mounting surface to be spaced apart from the base plate, underneath the mounting surface there being a recess in the carrier part. Here in particular it can be provided that the bottom of the mounting surface is connected to the base plate via a surface which is essentially shaped like a segment of a circle or a part of a rectangle in cross section and which extends into the carrier part. The recess underneath the mounting surface makes it possible for example to place a catch tray or the like on the base plate under the cutting plane of the cutting blade so that the sliced material can fall directly into the receiving tray. Furthermore the recess ensures that the base plate can be easily cleaned underneath the cutting plane. In doing so the surface with the shape of a segment of a cylinder jacket constitutes one simple possible implementation of one such recess.

According to one preferred embodiment of this invention, it is provided that the carrier part in the displacement direction of the carriage extends essentially over the entire width of the base plate. Furthermore, as claimed in the invention it is possible for the carrier part to extend in the direction perpendicular to the displacement direction of the carriage or parallel to the axis of rotation of the blade from one side of the base plate roughly one half of the length of the base plate. The carrier part thus extends roughly over half the surface of the base plate, conversely from the carrier part, specifically from the mounting surface the motor housing and the stop plate project over the part of the base plate which is not covered by the carrier part. In this way, on the one hand the motor housing is securely held with respect to the center of gravity.

On the other hand, the base plate can be used underneath the motor housing, for example for setting up the aforementioned receiving tray.

There is furthermore the possibility, that sealing caps for concealing the interior of the carrier part can be seated on the face ends of the carrier part. The end faces of the carrier part and thus the end faces of the cutting machine can be optically enhanced by the sealing caps.

It is possible for the motor housing with the blade and the carriage to be able to swivel at least relative to part of the base plate around one axis which extends essentially in the displacement direction of the carriage. By swiveling the motor housing together with the blade and carriage relative to at least one part of the base plate which forms a for example horizontal contact surface in this case, the support of the material to be cut and the cutting plane can be swiveled relative to the horizontal or the vertical such that the material to be cut can be supplied to the cutting plane supported by gravity.

The base plate can encompass two base plate parts which can be swiveled against one another such that due to their swiveling capacity against one another a swiveling capacity of the motor housing, blade and carriage relative to part of the base plate is enabled.

Alternatively, the carrier part can encompass a carrier bottom part and a carrier upper part which can be swiveled against one another such that due to the swiveling capacity of the carrier bottom part relative to the carrier top part the swiveling capacity of the motor housing, blade and carriage relative to at least one part of the base plate is enabled.

### BRIEF DESCRIPTION OF THE DRAWINGS

Other features and advantages of this invention are illustrated using the following description of preferred embodiments with reference to the attached figures:

FIG. 1 shows a side view of the first embodiment of the cutting machine as claimed in the invention;

FIG. 2 shows a perspective view of the cutting machine shown in FIG. 1 with the carriage removed;

FIG. 3 shows a perspective view of the cutting machine shown in FIG. 1 with the carriage removed and the motor housing removed;

FIG. 4 shows a perspective view of the base part as claimed in the invention of the cutting machine as claimed in the invention;

FIG. 5 shows a perspective view of a second embodiment of the cutting machine as claimed in the invention;

FIG. 6 shows a detailed view according to arrow VI in FIG. 5;

FIG. 7 shows a side view of the cutting machine shown in FIG. 6 with the carrier part swiveled up;

FIG. 8 shows a perspective view of a third embodiment of the cutting machine as claimed in the invention; and

FIG. 9 shows a perspective view of the fourth embodiment of the cutting machine as claimed in the invention.

### DETAILED DESCRIPTION OF THE INVENTION

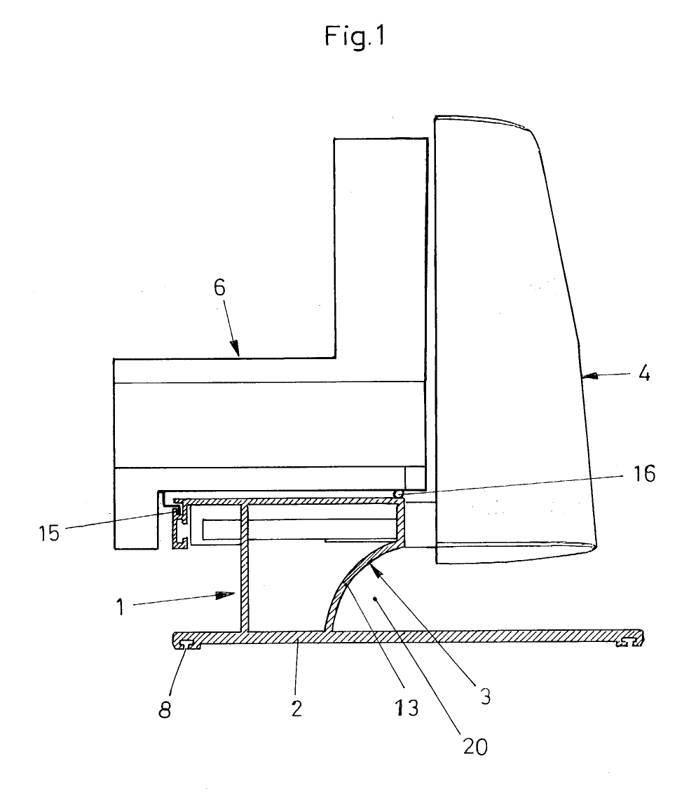

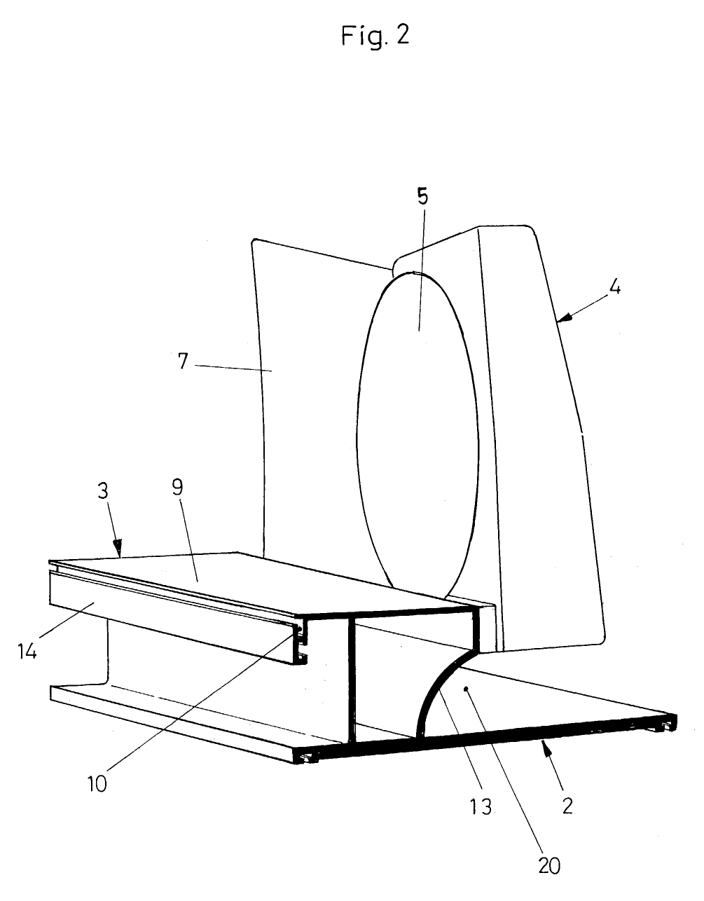

FIG. 1 and FIG. 4 show a preferred embodiment of a cutting machine as outlined in the invention. Disclosed is a base part 1 which encompasses a base plate 2 and a carrier part 3. The base part 1 which is shown crosshatched or darkened in the figures for clarity, is made essentially in one piece, for example of an aluminum extruded section. The cutting machine shown in FIGS. 1 to 4 furthermore encompasses a motor housing 4 on which the blade 5 is rotationally held. The blade 5 in the embodiment shown is a circular blade. Furthermore, the cutting machine encompasses a carriage 6 which can be moved parallel to the cutting plane of the blade 5 and which is used to support the material to be cut. Furthermore the cutting machine encompasses a stop plate 7 along which the material to be cut can be guided. The stop plate 7 can, as known from the prior art, be adjusted in the direction perpendicular to the cutting plane in order to be able to vary the thickness of the cut slice of material.

FIG. 1 shows that on the bottom of the base plate 2 there are recesses 8 for the support parts which can be inserted into the recesses 8. The support parts can be for example rubber strips or the like which can be used for nonslip support of the base plate 2 on the corresponding resting surfaces.

The carrier part 3 encompasses means for guiding the carriage 6 which are apparent in their interaction with the carriage 6 especially from FIG. 1. The carrier part 3 extends from the base plate 2 upward and has a top surface 9 which is spaced apart and extends parallel to the base plate 1 essentially over the entire length of the base plate 2. In the direction perpendicular to the cutting plane of the blade 5 the top surface 9 extends roughly from the edge of the base plate 2 which is the left edge in FIG. 1 spaced relative to it roughly to the center of the base plate 2. In the connecting area 2 to the base plate 2 the carrier part 3 in the direction perpendicular to the cutting plate of the blade 5 has a width which is roughly half the aforementioned width of the top surface 9 in this direction.

On the side of the top surface 9 facing away from the cutting blade, under this surface 9 there is a rear-receiving groove 10 which is part of the carriage guidance means. A rear engagement part 15 which is located accordingly on the bottom of the carriage 6 can fit into this rear-receiving groove 10 and can be guided in the receiving groove 10. Furthermore, on the bottom of the carriage 6 there are front support elements 16 which can slide on the top surface 9 on the side of the top surface 9 facing away from the rear receiving groove 10. The top surface 9 and the rear-receiving groove 10 of the carrier part 3 thus form means for guiding the carriage 6.

On the side facing away from the receiving groove 10 the carrier part 3 has a front mounting surface 11 which extends down essentially perpendicularly from the top surface 9 and to which the motor housing 4 can be attached with suitable means. For example, the motor housing 4 can be screwed onto this front mounting surface 11. The motor housing 4 is thus mounted laterally on the carrier part 3. The front mounting surface 11 is likewise used for attachment of the stop plate 7, for which the front mounting surface 11 has a hole 12 through which an adjustment bar 19 which is encompassed by an adjustment unit 17 for the stop plate 7 can extend. The adjustment bar 19 is dynamically connected to a cam disk within a rotary knob 18 which is likewise encompassed by the adjustment unit 17. By turning the knob 18 the distance of the stop plate 7 to the cutting plane of the blade 5 and thus the thickness of the cut material can be changed.

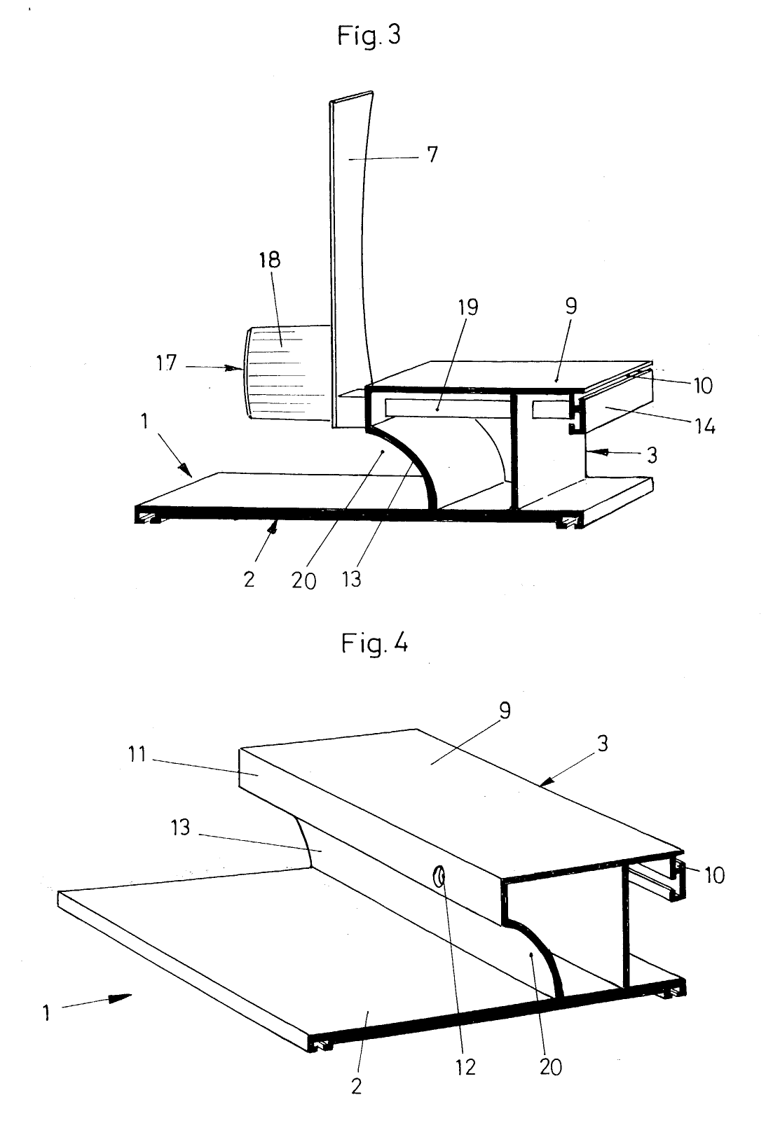

FIG. 3 shows that the adjustment bar 10 furthermore projects through a hole in the surface of the carrier part 3 which is spaced apart from the mounting surface 11 and is parallel to it so that the adjustment bar 10 is securely held. This second surface of the carrier part 3 which is parallel to the front mounting surface 11 extends perpendicularly between the base plate 2 and the top surface 9 parallel to the base plate 2.

The carrier part 3 furthermore encompasses a surface 13 which extends to the right in FIG. 1 and up from the base plate 2 and which has the shape of a segment of a cylinder jacket. The surface 13 which has the shape of a segment of a cylinder jacket ends on its side facing away from the base plate 2 on the bottom edge of the front mounting surface 11. On the side facing away from the front mounting surface 11 the carrier part 3 furthermore has a rear concealment edge 14 which extends down a distance from the rear-receiving groove 10 and can optically improve the carrier part 3 or the base part 1. In particular end caps can be placed on the carrier part 3 and can cover on the end face the space between the front mounting surface 11 and the surface 13 which has the shape of a segment of a cylinder jacket on one side and the rear concealment edge 14 on the other side.

As a result of the surface 13 which has the shape of a segment of a cylinder jacket, underneath the front mounting surface 11 a recess 20 forms between the motor housing 4 attached to the mounting surface 11 and the base plate 2 so that for example the receiving tray or the like for the material to be cut can be pushed to under the cutting plane of the blade 5.

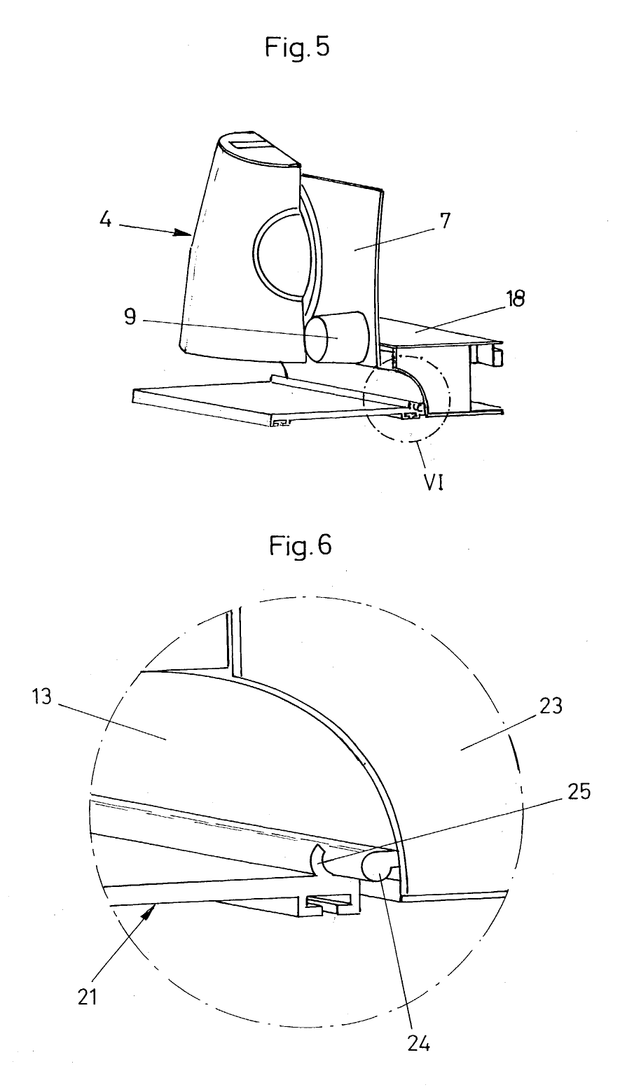

A second embodiment of the cutting machine as claimed in the invention is shown in FIG. 5 to FIG. 7. In this cutting machine the same parts are provided with the same reference numbers as in FIGS. 1 to 4.

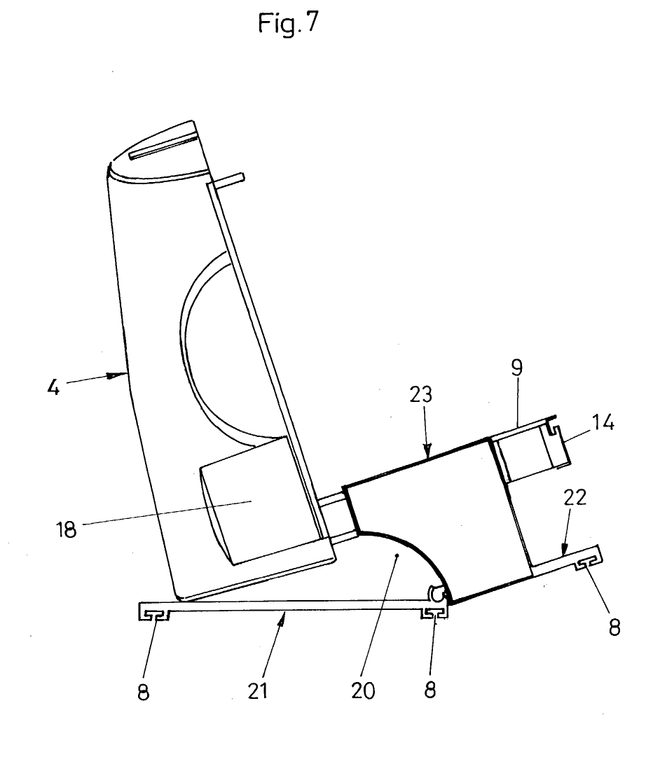

In the illustrated second embodiment of a cutting machine as claimed in the invention, the base plate is made in two parts with a base plate part 21 which is on the left in FIG. 7 and a base plate part 22 which is on the right in FIG. 7. The base plate part 22 which is on the right in FIG. 7 is connected to the carrier part 23 which corresponds essentially to the carrier part 3 of the first embodiment as shown in FIG. 1 to FIG. 4. The carrier part 23 can likewise be connected in one piece to the right base plate part 22 and can be made especially together with it as an extruded part. But it is also possible for the right base plate 22 and the carrier plate 23 to be made separately from one another and attached to one another.

The carrier part 23 is pivotally connected to the left base plate part 21. The swiveling capacity is achieved via hinge means which extend essentially in the displacement direction of the carriage. The hinge means encompass a projecting strip 24 which extends essentially in the displacement direction of the carriage on the carrier part 23 and the groove 25 which is located on the left base plate part 21 and which extends in the displacement direction of the carriage.

This swiveling capacity of the carrier part 23 relative to the left, larger base part 21 yields the swiveling capacity of the carriage 6 which is used as the support of the material to be cut together with the blade 5 and the motor housing 4 counterclockwise in FIG. 7. The support of the material to be cut provided by the carriage 6 can be tilted relative the horizontal, for example by 10° to 30°. The material to be cut can thus be supplied to the blade 5 supported by gravity.

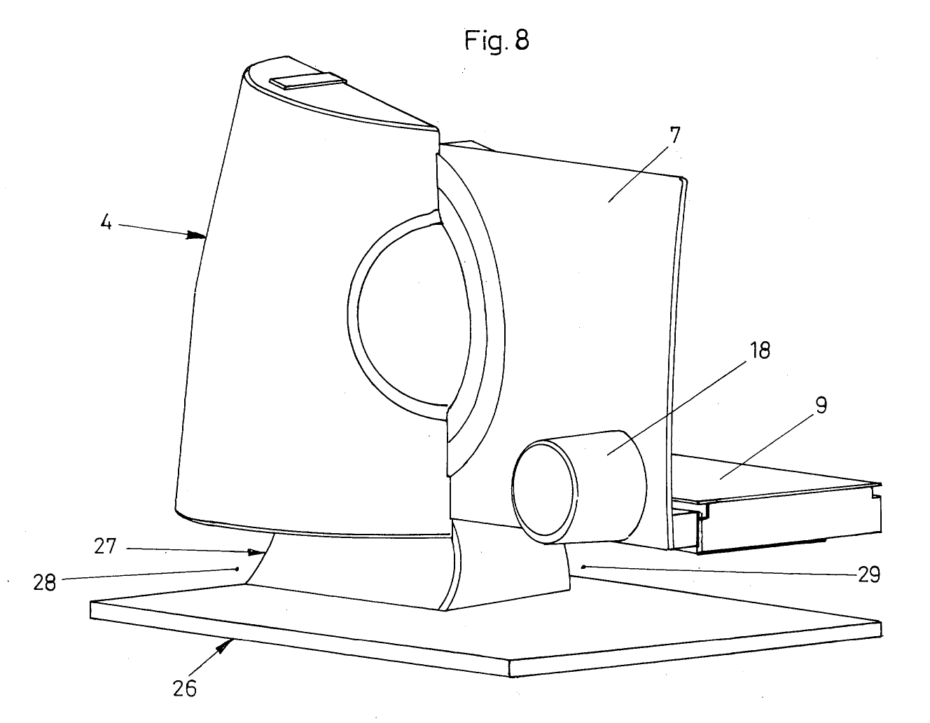

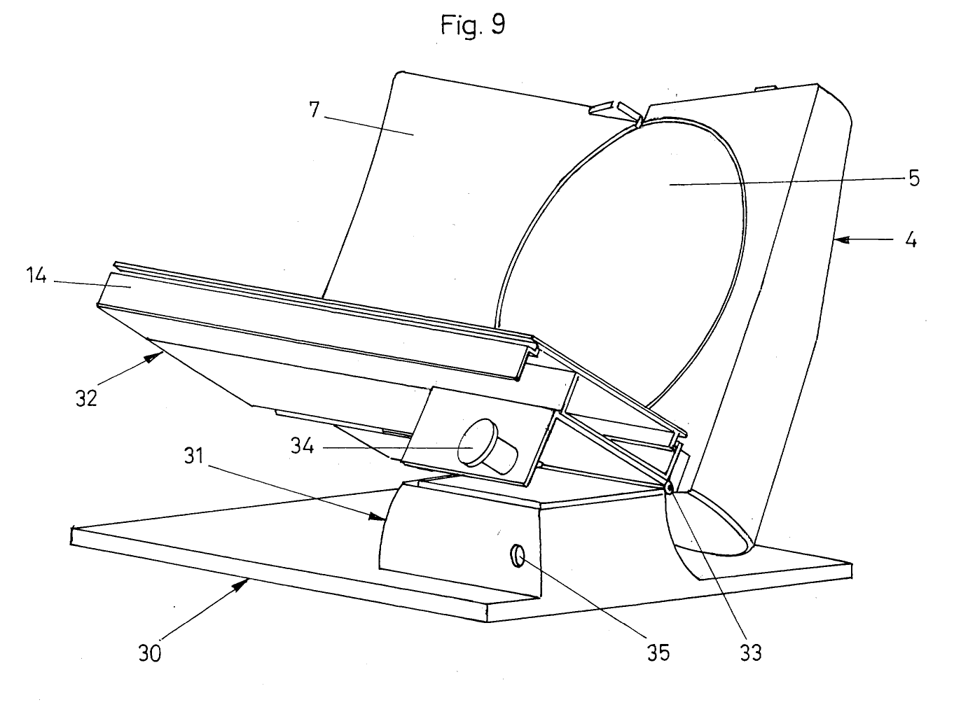

FIG. 8 shows a third embodiment of a cutting machine as claimed in the invention. In this embodiment the base plate 26 is connected to the carrier part 27 which is essentially smaller than the carrier part 3 of the first embodiment as shown in FIG. 1 to FIG. 4. In particular, the carrier part 27 does not extend in the displacement direction of the carriage over the entire length of the base plate 26. In the way, not only under the motor housing 4 is a recess 28 formed, but also under the stop plate 7 another recess 29 is formed. The space underneath the motor housing 4 and underneath the stop plate 7 or underneath the carriage can thus be used likewise for insertion of articles, for receiving trays or the like. Furthermore, the base plate 26 can be cleaned more easily in these areas.

In this embodiment, the base plate 26 and the carrier part 27 can be made either as a one-piece, for example, extruded base part or as separately manufactured parts which are connected to one another in another working process.

FIG. 9 shows a fourth embodiment of a cutting machine as claimed in the invention. This embodiment corresponds with respect to the shape and size of the carrier part essentially to the embodiment as shown in FIG. 8. But it is different here that the motor housing 4 and the carriage can be swiveled relative to the base plate 30. This is achieved in this embodiment in that the carrier part is divided into a carrier bottom part 31 and a carrier top part 32 which can be swiveled against one another around a hinge means 33. The swiveling axis extends as in the second embodiment as shown in FIG. 5 to FIG. 7 likewise horizontally in the displacement direction of carriage. FIG. 9 furthermore shows that a locking screw 34 is mounted on the carrier top part 32 and can fit into an opening 35 on the carrier bottom part 31 in the unswiveled state of the carrier top part 32 relative to the carrier bottom part 31 in order to fix the carrier top part 32 on the carrier bottom part 31.

What is claimed is:

1. A cutting machine for food comprising:
a motor housing with one blade rotationally held thereto;
a carriage used to support a material to be cut and which can be moved parallel to a cutting plane of the blade, and means for carriage guidance to which the carriage is attached; and
a base plate which is used for holding the motor housing, wherein the cutting machine has a base part which encompasses the base plate and a carrier part essentially in one piece with it, the motor housing being held on the carrier part.

2. A cutting machine for food comprising:
a motor housing with one blade rotationally thereto;
a carriage used to support the material to be cut and which can be moved parallel to a cutting plane of the blade, and means for carriage guidance to which the carriage is attached; and
a base plate which is used for holding the motor housing, wherein between the motor housing and the base plate there is a carrier part which holds the motor housing, the carrier part being made such that between the motor housing and the base plate a recess is formed into which articles can be inserted from the outside.

3. The cutting machine as claimed in claim 2, wherein the recess extends essentially parallel to a displacement direction of the carriage.

4. The cutting machine as claimed in claim 2, wherein the carrier part is made such that between the carriage and the base plate a recess is formed into which articles can be inserted from the outside.

5. The cutting machine as claimed in claim 2, wherein at least one recess in the connection direction between the base plate and the motor housing or between the base plate and the carriage at least in sections has an extension of at least 2 cm.

6. The cutting machine as claimed in claim 1, wherein means for guiding the carriage are made on the carrier part.

7. The cutting machine as claimed in claim 2, wherein means for guiding the carriage are made on the carrier part.

8. The cutting machine as claimed in claim 1, wherein the base part is made as an aluminum extruded section.

9. The cutting machine as claimed in claim 2, wherein the base part is made as an aluminum extruded section.

10. The cutting machine as claimed in claim 6, wherein the means for guiding the carriage encompasses a receiving groove which is made on the carrier part, which extends in a displacement direction of the carriage, and into which the receiving groove of the carriage can fit.

11. The cutting machine as claimed in claim 7, wherein the means for guiding the carriage encompasses a receiving groove which is made on the carrier part, which extends in the displacement direction of the carriage and into which the receiving groove of the carriage can fit.

12. The cutting machine as claimed in claim 6, wherein the means for guiding the carriage comprise a top surface which is made on the carrier part, which is located spaced apart and parallel to the base plate and which is used as a support surface for the corresponding support element of the carriage.

13. The cutting machine as claimed in claim 7, wherein the means for guiding the carriage comprise a top surface which is made on the carrier part, which is located spaced apart and parallel to the base plate and which is used as a support surface for the corresponding support element of the carriage.

14. The cutting machine as claimed in claim 1, wherein the cutting machine has a stop plate which is aligned parallel to the cutting plane of the blade and which can be moved in the direction perpendicular to the cutting plane of the blade in order to vary the thickness of the cut slice of the material which was to be cut.

15. The cutting machine as claimed in claim 2, wherein the cutting machine has a stop plate which is aligned parallel to the cutting plane of the blade and which can be moved in the direction perpendicular to the cutting plane of the blade in order to vary the thickness of the cut slice of the material which was to be cut.

16. The cutting machine as claimed in claim 14, wherein the stop plate is mounted on the carrier part.

17. The cutting machine as claimed in claim 15, wherein the stop plate is mounted on the carrier part.

18. The cutting machine as claimed in claim 1, wherein the carrier part has a mounting surface which is aligned perpendicular to the base plate and to which the motor housing is attached.

19. The cutting machine as claimed in claim 2, wherein the carrier part has a mounting surface which is aligned perpendicular to the base plate and to which the motor housing is attached.

20. The cutting machine as claimed in claim 18, wherein the stop plate is adjustably mounted on the mounting surface.

21. The cutting machine as claimed in claim 19, wherein the stop plate is adjustably mounted on the mounting surface.

22. The cutting machine as claimed in claim 18, wherein the bottom of the mounting surface is spaced apart from the base plate, underneath the mounting surface there being a recess in the carrier part.

23. The cutting machine as claimed in claim 19, wherein the bottom of the mounting surface is spaced apart from the base plate, underneath the mounting surface there being a recess in the carrier part.

24. The cutting machine as claimed in claim 22, wherein the recess is attained by the bottom of the mounting surface being connected to the base plate via a surface which is essentially shaped like a segment of a circle or a part of a rectangle in cross section and which extends into the carrier part.

25. The cutting machine as claimed in claim 23, wherein the recess is attained by the bottom of the mounting surface being connected to the base plate via a surface which is essentially shaped like a segment of a circle or a part of a rectangle in cross section and which extends into the carrier part.

26. The cutting machine as claimed in claim 1, wherein the carrier part in the displacement direction of the carriage extends essentially over an entire width of the base plate.

27. The cutting machine as claimed in claim 2, wherein the carrier part in the displacement direction of the carriage extends essentially over an entire width of the base plate.

28. The cutting machine as claimed in claim 1, wherein the carrier part in the displacement direction of the carriage extends essentially only underneath the motor housing.

29. The cutting machine as claimed in claim 2, wherein the carrier part in the displacement direction of the carriage extends essentially only underneath the motor housing.

30. The cutting machine as claimed in claim 1, wherein the carrier part extends in the direction perpendicular to the displacement direction of the carriage or parallel to the axis of rotation of the blade from one side of the base plate roughly one half of the length of the base plate.

31. The cutting machine as claimed in claim 2, wherein the carrier part extends in the direction perpendicular to the displacement direction of the carriage or parallel to the axis of rotation of the blade from one side of the base plate roughly one half of the length of the base plate.

32. The cutting machine as claimed in claim 1, wherein sealing caps for concealing the interior of the carrier part can be seated on the face ends of the carrier part.

33. The cutting machine as claimed in claim 2, wherein sealing caps for concealing the interior of the carrier part can be seated on the face ends of the carrier part.

34. The cutting machine as claimed in claim 1, wherein the motor housing with the blade and the carriage can be swiveled at least relative to part of the base plate around one axis which extends essentially in the displacement direction of the carriage.

35. The cutting machine as claimed in claim 2, wherein the motor housing with the blade and the carriage can be swiveled at least relative to part of the base plate around one axis which extends essentially in the displacement direction of the carriage.

36. The cutting machine as claimed in claim 34, wherein the base plate encompasses two base plate parts which can be swiveled against one another such that due to their swiveling capacity against one another a swiveling capacity of the motor housing, blade and carriage relative to part of the base plate is enabled.

37. The cutting machine as claimed in claim 35, wherein the base plate encompasses two base plate parts which can be swiveled against one another such that due to their swiveling capacity against one another a swiveling capacity of the motor housing, blade and carriage relative to part of the base plate is enabled.

38. The cutting machine as claimed in claim 34, wherein the carrier part encompasses a carrier bottom part and a carrier top part which can be swiveled against one another such that due to the swiveling capacity of the carrier bottom part relative to the carrier top part a swiveling capacity of the motor housing, blade and carriage relative to at least part of the base plate is enabled.

39. The cutting machine as claimed in claim 35, wherein the carrier part encompasses a carrier bottom part and a carrier top part which can be swiveled against one another such that due to the swiveling capacity of the carrier bottom part relative to the carrier top part a swiveling capacity of the motor housing, blade and carriage relative to at least part of the base plate is enabled.

40. The cutting machine as claimed in claim 1, wherein the base part encompasses the base plate and the carrier part in one piece.
